(19) United States
(12) Patent Application Publication
(10) Pub. No.: US 2004/0150839 A1
(43) Pub. Date: Aug. 5, 2004

(54) Method for measuring the spatial position and/or opening of a work piece

(76) Inventors: Ralf Christoph, Schoeffengrund (DE); Matthias Andras, Florstadt (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/481,411

(22) PCT Filed: Jul. 5, 2002
(86) PCT No.: PCT/EP02/07471

(30) Foreign Application Priority Data
Jul. 16, 2001 (DE) 101 33 840.6

(51) Int. Cl. G01B 11/00

(52) U.S. Cl. 356/626

(57) ABSTRACT

A method for measuring the spatial position and/or opening such as a bore of a work piece by means of a transmitted light process using at least one optical sensor, in a manner which has high precision and is simple. At least two parallel sections between the light cone emerging from the opening and at least two working planes are measured by optical sensors, and the axial direction of the opening is calculated using straight lines which extend between the mid-points of the curves determined thereby.

The invention relates to a process for the measurement of spatial positions and/or dimensions of a perforation such as bores of a work piece in the transmitted light process by using at least one optical sensor.

A process for the measurement of bores in fuel injection valves for combustion engines is known from DE 196 11 613 A1 where the run-out edges of the bores are measured consecutively, for example, with a CCD camera. Here the fuel valve is clamped into amounting device and adjusted with the mounting device into a geometrically determined position before the measurement process.

In order to measure bores of a work piece that are not easily accessible opto-electronically, according to DE 100 09 946 A1 a mirror is placed in the vicinity of the bore within the work piece and aligned to the optical axis of the opto-electronic capturing device, whereby the light source itself is located outside of the work piece.

The present invention is based on the problem to further develop a process of the above mentioned type such that perforations such as bores can be measured with high precision with constructively simple measures.

To solve this problem, the invention essentially suggest that at least two parallel sections of the light cone exiting the perforation and at least two working planes are measured by optical sensors and that the axis direction of the perforation is calculated by the straight between the centers of the curves determined by this method.

The center point can also be the center point of a connector circle of the measured surface, whose surface gravity point or other mathematical point can be a geometric value like a square that is adjusted to the measured surface.

In other words, it is suggested that various cutting planes of the light cone are measured simultaneously and evaluated with at least two sensors, which can be physically realized by an optical sensor with a CNC adjustable working distance. Preferably, the work piece, or the perforation, and the optical sensors are aligned to each other in such a way that the sections form a circle so that the straight going through their centers results in the center axis of the perforation.

The perforation, such as the bore with the work piece can be positioned on a coordination measurement device through rotating and/or pivotal axes. In addition or as an alternative, the sensors can be positioned together on a rotating pivotal unit in order to simply facilitate the alignment of perforation and sensors.

Especially image processing sensors such as CCD sensors or cameras with an evaluation device should be considered. The optical axes of the sensors can be aligned with a beam splitter on a common beam path.

It is especially provided for the determination of the cross section or the diameter of the opening or perforation that a working distance or a working plane of a sensor runs in a level spanning from run-out edges of the perforation.

The cross section of the perforation or its diameter can also be determined from the sections running at a distance of the run-out edges between light cone and working planes under consideration of the distance of the sensors to the work piece. A distance sensor can be used for that.

The measurements take place especially with an opto-tactile scanner whose scanning element is optically and interactively captured with the perforation or its delimitation as is known from EP 0988505 to which is expressively referred to on the disclosure. The opto-tactile scanners are invisible for the additional optical sensors, which determine the next steps, by positioning them outside of their sharpness levels and are measured by an additional optical sensor with the appropriate sharpness level.

A diffuse light source or diffuse light is used for the transmitted light whose expansion is larger than the cross section of the perforation on the sensor-averted surface.

Additional details, advantages and characteristics of the invention not only result from the claims and the characteristics derived from them—for themselves and/or in combination—but also from the following descriptions of the design examples presented in the drawings.

They show:

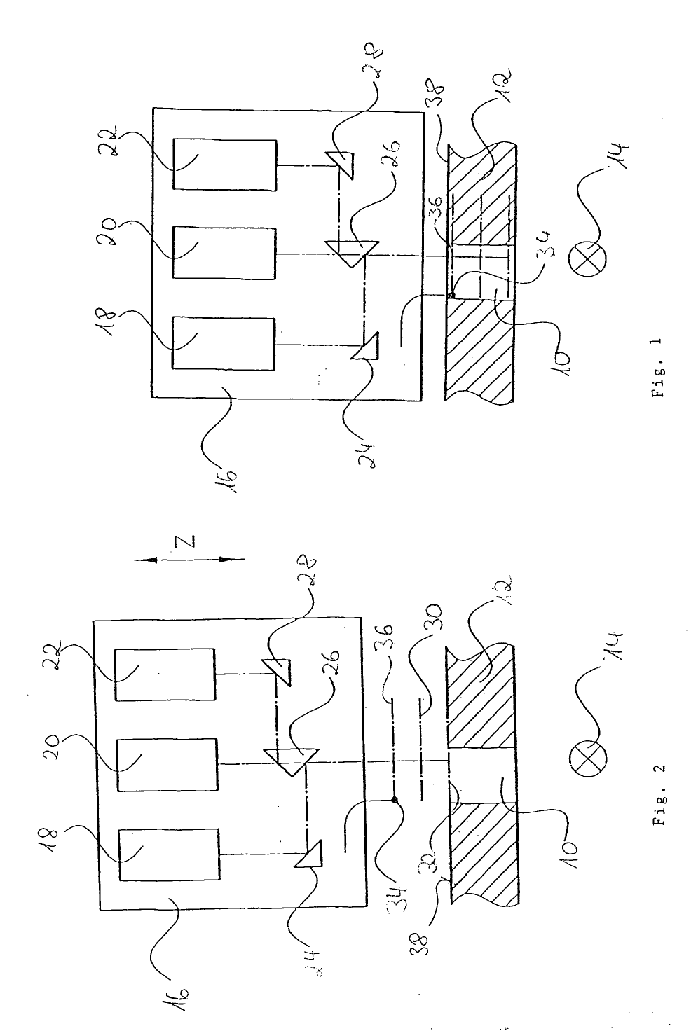

FIG. 1 a principal presentation of a layout for the determination of a spatial position and/or measurement of a bore and

FIG. 2 a layout according to FIG. 1 with a measuring head adjusted to the z-direction.

Purely in principle a measurement arrangement, especially a coordination measurement device, is shown in order to measure dimensions or positions of bores or penetrations 10 of a work piece 12. Here the transmitted light process is used, meaning that a measurement head 16 of the measurement arrangement is adjustably positioned opposite the light source 14 of the work piece 12 in order to measure the bore 10.

The measuring head 16 that must be aligned as an integral unit with the work piece 12 or the bore 10 via a rotating pivotal unit that is not shown is provided in the design example with opto-electronic capturing devices 18, 20, 22 such as CCD sensors that are connected with the evaluation devices that are not shown.

The work piece 12 can be located at a measurement table of a coordinate measuring device and can be, for example, aligned with the measuring head 16 via rotating/pivotal axes that can be adjusted in the X-, Y- and Z-direction independent of the adjustment options of the rotating/pivotal unit. In the design example, the sensors 20, 22 are optical image processing sensors whose working distances and, therefore, working planes or object planes 30, 32 deviate from each other and show, therefore, a deviating distance from the measurement head 16, as the principal drawing shows.

The light put through the bore 10 reaches the sensors 18, 20, 22 through the beam splitters 24, 26, 28.

In addition, an opto-tactile sensor with a scanning element 34 is provided which is located in the working plane 36 of the optical sensor 18.

In order to determine the axial direction of the bore 10 the bore 10 is illuminated with light from the light source 14. The light source 14 emits diffuse light or light whose expansion is greater than the clearance of the bore 10. The axial direction is determined by measuring the sections of the light cone leaving the bore 10 with the working or object planes 30, 32 of the sensors 20, 22. With proper alignment of the work piece 12 with the measuring head 16, they are circular sections. Through the determination of their centers or the penetration points of the two circles the axial direction of the bore 10 is determined.

In addition, the geometry or the diameter of the bore 10 in the area of the outer surface of the work piece 12, meaning the area of the outlet edges of the bore 10, can be measured directly with the image processing sensor 20 through the image of the boring.

In addition an opto-tactile measurement of the bore 10 can take place by bringing the scanning element 34 in contact with the wall of the bore 10. The scanning element 34 is a segment such as the end of a fiber scanner 40 that is connected with the measuring head 16. In case of a contact with the wall of the bore 10 a displacement of the scanning element 34 takes place, which is captured for the determination of a measuring point through the optical sensor 18. In this respect it is referred to the disclosure of the European Patent Application 0 988 505.

If the image processing sensors 20, 22 are used, the opto-tactile sensor 34, which can also be called scanning form element or fiber scanner, is located in the fuzziness area and is, therefore, not visible.

If the scanning element 34 is used for measurements, the measuring head 16 is adjusted in the z-direction so that the scanning element is engaged with the boring 10. This can be seen by comparing FIG. 1 and 2.

The dimensioning of the exit opening of the bore 10 can also be determined if there are no working planes 30, 32 of the sensors 20, 22 in the span plane of the outlet edges of the bore 10. In this case, the dimensioning of the bore 10 can be calculated from the ratio of the section between the light cone and the working planes 30, 32 and the distance of the measuring head 16 to the surface 38 of the measurement object 12. In order to determine the distance, an additional distance sensor, which is not shown, can be used.

Process for the Measurement of spatial Positions and/or Dimension of a Perforation of a Work Piece:

1. Process for the measurement of spatial positions and/or dimensions of a perforation such as bores of a work piece in the transmitted light process by using at least one optical sensor, characterized in that at least two parallel sections of the light cone exiting the perforation and at least two working planes are measured by optical sensors and that the axial direction of the perforation is calculating by using the straight lines extending between the centers of the curves determined this way.

2. Process according to claim 1, characterized in that a working plane of a sensor runs in a plane facing the sensor and containing the perforation.

3. Process according to claim 1 or 2, characterized in that a diffused light source or diffused light is used for the transmitted light.

4. Process to one of the above claims, characterized in that one light source is used whose expansion is larger than that of the surface of the work piece that is averted from the sensor of the perforation.

5. Process according to at least one of the above claims, characterized in that the parallel sections between the light cone and the working planes are measured simultaneously.

6. Process according to at least one of the above claims, characterized in that the object is captured via a beam splitter by sensors with working distances deviating from one another.

7. Process according to at least one of the above claims, characterized in that a single sensor with an adjustable working distance is used for the measurement of two sections between the light beam and the working planes.

8. Process according to at least one of the above claims, characterized in that a sensor with a CNC adjustable working distance is used.

9. Process according to at least one of the above claims, characterized in that image processing sensors are used as sensors to measure the sections.

10. Process according to at least one of the above claims, characterized in that in addition to the image processing sensor(s), a tactile or opto-tactile sensor is used for the measurement of the circumference geometry or the diameter of the perforation.

11. Process according to one of the above claims, characterized in that the scanning element, touching the perforation, of the tactile or opto-tactile sensor runs outside the working distances of the image processing sensors.

12. Process according to at least one of the above claims, characterized in that the distance between the measuring head containing the sensors and the surface of the work piece facing the sensor and containing the perforation is measured via a distance sensor.

13. Process according to at least one of the above claims, characterized in that the perforation and the sensors are aligned in such a way that the section forms a circle or almost a circle.

14. Process according to at least one of the above claims, characterized in that the work piece is positioned on a coordination measurement device through rotating and/or pivotal axes.

15. Process according to at least one of the above claims, characterized in that the measuring head holding the sensors can be adjusted with a rotating pivotal unit.

16. Process according to at least one of the above claims, characterized in that the tactile or opto-tactile sensor is integrated in the measuring head.
